(19) United States
(12) Patent Application Publication
(10) Pub. No.: US 2008/0320069 A1
(43) Pub. Date: Dec. 25, 2008

(54) VARIABLE LENGTH FFT APPARATUS AND METHOD THEREOF

(76) Inventors: Yi-Sheng Lin, Taipei County (TW); Chingwo Ma, Danville, CA (US); Shu-Mei Li, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/766,783

(22) Filed: Jun. 21, 2007

(51) Int. Cl. G06F 15/00

(52) U.S. Cl. 708/404

(57) ABSTRACT

The invention discloses a variable length FFT apparatus and a method thereof. The FFT apparatus includes a split-radix based FFT unit and a multiplexing unit. The split-radix based FFT unit has a plurality of processing elements cascaded in a series. The multiplexing unit is coupled to the split-radix based FFT unit, and is for selectively bypassing at least one of the processing elements according to the size of input data when the split-radix based FFT unit performs the FFT computation on the input data. The FFT apparatus of the present invention therefore has a simple structure and is flexible for any FFT size.

### BACKGROUND OF THE INVENTION

1. Field of the Invention

The invention relates to a Fast Fourier Transform (FFT) apparatus, and more particularly, to a variable length FFT apparatus based on a split-radix based FFT unit.

2. Description of the Prior Art

The Fast Fourier Transform (FFT), which recursively breaks a discrete Fourier transform (DFT) into many smaller DFTs of smaller sizes, is an efficient algorithm for computing the DFT. Therefore FFT is highly important in a wide variety of applications, from digital signal processing to orthogonal frequency division multiplexing (OFDM) systems,such as digital audio broadcasting (DAB), wireless LAN and ADSL.

There has always been a tendency to further decrease the complexity and shorten the calculating time of an FFT computation. It turns out that the lowest count can be achieved by using a modification of a split radix FFT algorithm, for example, a conventional radix-2/4/8 FFT as shown in FIG. 1. As the operation of the radix-2/4/8 FFT is well-known to those skilled in this art, further description is omitted here for brevity. Please refer to FIG. 2 in conjuntion with FIG. 1. FIG. 2 is a block diagram of a conventional radix-2/4/8 FFT unit 200 based on the radix-2/4/8 FFT shown in FIG. 1. The radix-2/4/8 FFT unit 200 comprises 3 elements known as the first processing element (PE1) 210, the second processing element (PE2) 220 and the third processing element (PE3) 230 respectively, wherein the PE1 210 is in charge of the first stage computations of the radix-2/4/8 FFT, while the PE2 220 is in charge of the second stage computations of the radix-2/4/8 FFT, and so on. Taking PE3 230 as an example, a butterfly (BF) 232 is configured to convert two inputs into two outputs. One output of the BF 232 is stored in the shift register 234 to be processed later, and the other output of the BF 232 is multipled by the twiddling factor stored in the memory 236, and then delayed by one clock due to being stored in the shift register 238 for outputting once the next clock arrives. Note that the twiddling factors of the first and second stages of the radix-2/4/8 FFT are simplified so that the complicated multiplication can be omitted in PE1 210 and PE2 220. This makes the radix-2/4/8 FFT unit 200 able to operate in a high-speed environment and requires less memory for data storage.

Although the radix-2/4/8 FFT unit 200 has the above-mentioned advantages, it can only perform 8ⁿ-point FFT, that is, the FFT length that the radix-2/4/8 FFT unit 200 can handle is fixed and limited. However, the FFT length required in a communication system always varies. For example, there are four modes in digital audio broadcasting systems, and each mode requires a different length of FFT computation, such as 2048, 512, 256 or 1024. These FFT lengths are not all powers of 8; therefore the radix-2/4/8 FFT unit 200 cannot be implemented directly in the digital audio broadcasting systems.

To solve this problem and extend the application field of the radix-2/4/8 FFT, a conventional variable length FFT apparatus 300 shown in FIG. 3 is proposed. As shown in FIG. 3, a radix-2 FFT unit 304 is added at the input end of the radix-2/4/8 FFT unit 200 to form the variable length FFT apparatus 300. No matter what size the input data is, after being processed by the radix-2 FFT unit 304, the data input to the following radix-2/4/8 FFT unit 200 will have a size equal to 8ⁿ since the radix-2 FFT unit 304 can recursively break the input data into two parts. Please note that the circuit structure of the radix-2 FFT unit 304 is substantially the same as PE3 230 in FIG. 2, which necessitates the memory device being implemented in the radix-2 FFT unit 304. This increases the memory size required in the FFT apparatus 300 and raises the production cost.

### SUMMARY OF THE INVENTION

One objective of the claimed invention is therefore to provide a variable length FFT apparatus and a method thereof. The variable length FFT apparatus of the present invention has a simple structure and is flexible for any FFT size.

According to an exemplary embodiment of the invention, an FFT apparatus for performing an FFT computation on N input data comprises a split-radix based FFT unit and a multiplexing unit. The split-radix based FFT unit comprises a plurality of processing elements cascaded in a series. The multiplexing unit is coupled to the split-radix based FFT unit, and is for selectively bypassing at least one of the processing elements according to a value of N when the split-radix based FFT unit performs the FFT computation on the N input data.

According to another exemplary embodiment of the invention, an FFT apparatus for performing an FFT computation on N input data comprises a split-radix based FFT unit and a multiplexing unit. The split-radix based FFT unit comprises a plurality of processing elements cascaded in a series. The multiplexing unit is coupled to the split-radix based FFT unit, and is for selectively outputting the N input data or an output of a specific processing element as an input of a final processing element of the split-radix based FFT unit according to a value of N when the split-radix based FFT unit performs an FFT computation on the N input data, wherein the specific processing element precedes the specific processing element.

According to another exemplary embodiment of the invention, a method for performing an FFT computation on N input data by utilizing a split-radix based FFT unit comprising a plurality of processing elements is disclosed. The method comprises selectively bypassing at least one of the processing elements according to a value of N when the split-radix based FFT unit performs the FFT computation on the N input data.

According to another exemplary embodiment of the invention, a method for performing an FFT computation on N input data by utilizing a split-radix based FFT unit comprising a plurality of processing elements is disclosed. The method comprises selectively outputting the N input data or an output of a specific processing element as an input of a final processing element of the split-radix based FFT unit according to a value of N when the split-radix based FFT unit performs an FFT computation on the N input data, wherein the specific processing element precedes the specific processing element.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a conventional radix-2/4/8 FFT.

FIG. 2 is a block diagram of a conventional radix-2/4/8 FFT unit based on the radix-2/4/8 FFT shown in FIG. 1.

FIG. 3 is a block diagram of a conventional variable length FFT apparatus combining one radix-2 FFT unit with the radix-2/4/8 FFT shown in FIG. 1.

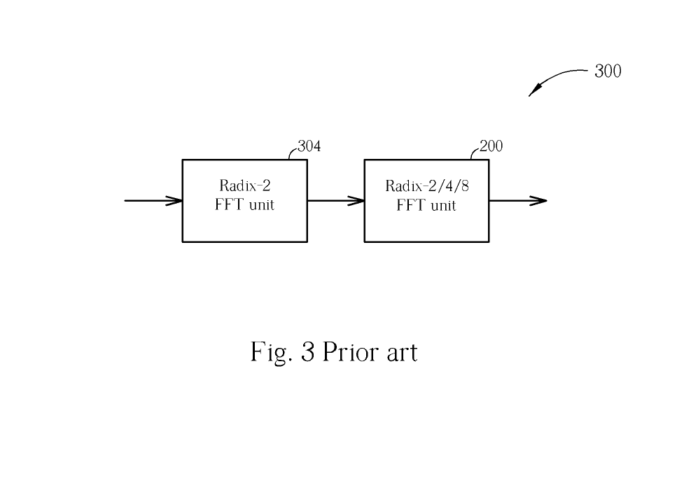

FIG. 4 is a diagram of a radix-2/4 FFT.

FIG. 5 is a block diagram of a variable length FFT apparatus according to an exemplary embodiment of the invention.

FIG. 6 is a block diagram of a variable length FFT apparatus according to another exemplary embodiment of the invention.

### DETAILED DESCRIPTION

Certain terms are used throughout the following description and claims to refer to particular system components. As one skilled in the art will appreciate, manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” The terms “couple” and “couples” are intended to mean either an indirect or a direct electrical connection. Thus, if a first device couples to a second device, that connection may be through a direct electrical connection, or through an indirect electrical connection via other devices and connections.

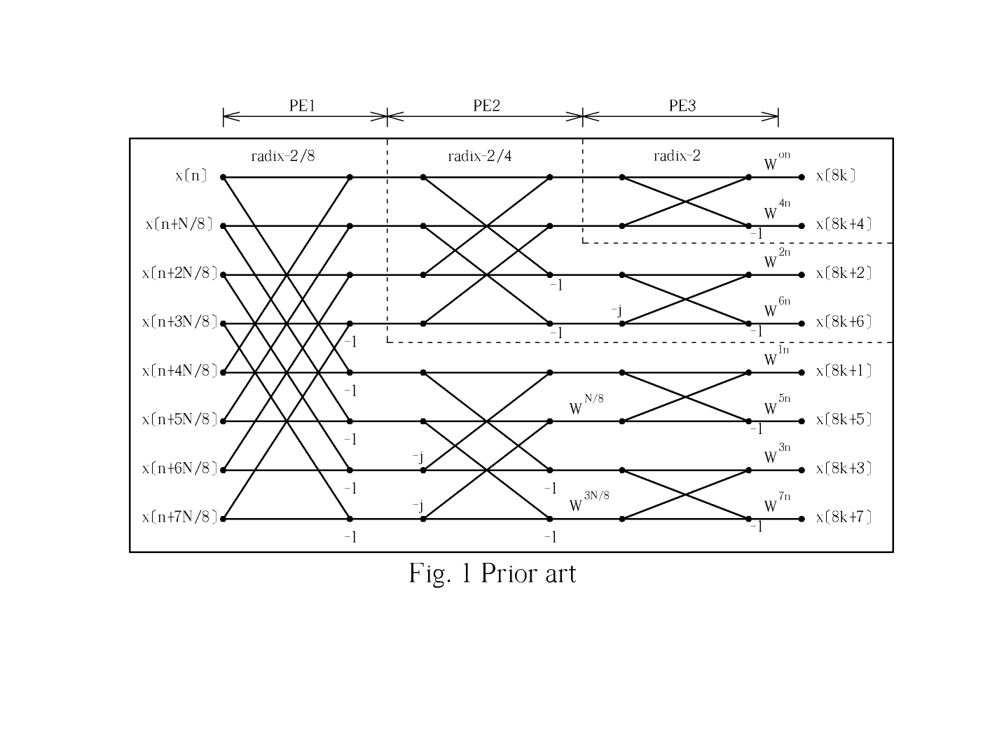

The present invention is based on a split-radix based FFT unit and an observation that, by bypassing some processing elements in the split-radix based FFT unit, the remaining processing elements will recombine to become an FFT unit having specific characteristics that is able to perform an FFT computation on input data of a specific size. Taking radix-2/4/8 FFT shown in FIG. 1 as an example, the formula of radix-2/4 FFT is represented as follows:

$$X [ 4 s + 1 ] = {\sum }_{n = 0}^{( N / 4 - 1 )} \{ ( x [ n ] - x [ n + N / 2 ] ) - j ( x [ n + N / 4 ] - x [ n + 3 N / 4 ] ) \} {W}_{N}^{n} {W}_{N / 4}^{ns}$$

$$X [ 4 s + 3 ] = {\sum }_{n = 0}^{( N / 4 - 1 )} \{ ( x [ n ] - x [ n + N / 2 ] ) + j ( x [ n + N / 4 ] - x [ n + 3 N / 4 ] ) \} {W}_{N}^{3 n} {W}_{N / 4}^{ns}$$

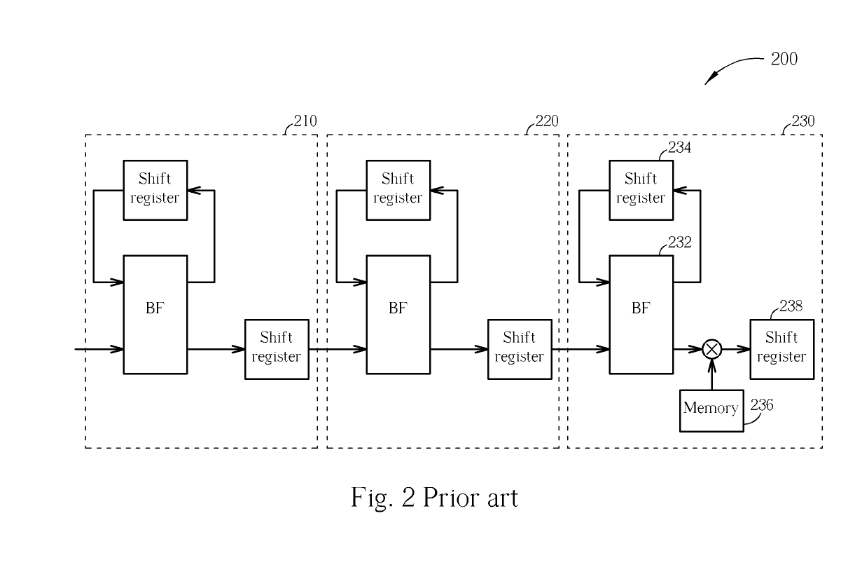

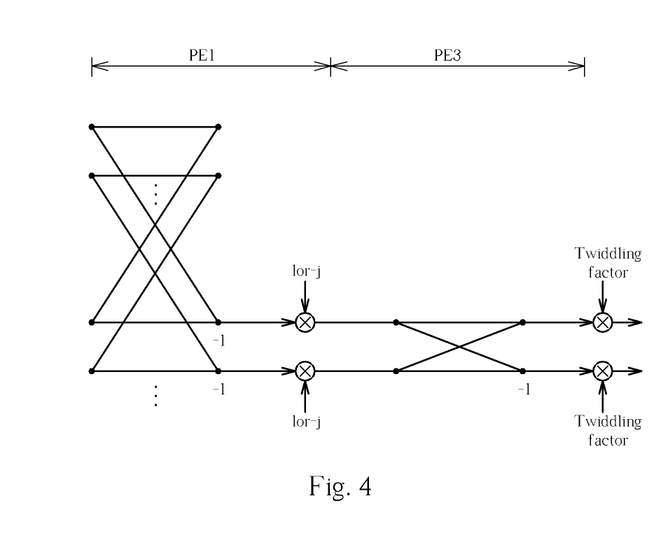

This can be carried out by PE1 210 and PE3 230 of the radix-2/4/8 FFT unit 200 as shown in FIG. 2. To explain the operation in a more detailed way, please refer to FIG. 4. FIG. 4 shows a diagram of an exemplary radix-2/4/8 FFT minus the second stage computation, which is substantially equivalent to bypassing the PE2 220 in the radix-2/4/8 FFT unit 200. As shown in FIG. 4, the FFT computation carried out by the PE1 together with PE3 converts 4 input data into 2 output data, wherein the relationship between the input data and the output data conforms with the above formula of radix-2/4 FFT. Therefore, the combination of PE1 210 and PE3 230 is a radix-2/4 FFT unit that performs a four-point FFT computation.

Moreover, since PE3 230 itself is a radix 2 FFT unit, when PE1 210 and PE2 220 are bypassed, the radix-2/4/8 FFT unit 200 will work as a radix 2 FFT unit which performs the FFT computation on input data with a size of two.

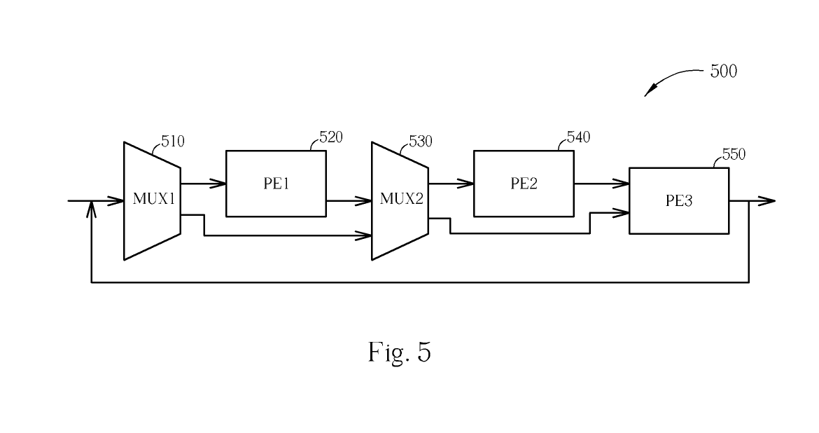

According to the operational principle disclosed above, a variable length FFT apparatus can be accomplished based on the split-radix based FFT unit. FIG. 5 shows a block diagram of a variable length FFT apparatus according to an exemplary embodiment of the invention. The FFT apparatus 500 comprises a split-radix based FFT unit and a multiplexing unit coupled to the split-radix based FFT unit. The split-radix based FFT unit comprises a plurality of processing elements cascaded in a series, such as the first processing element (PE1) 520, the second processing element (PE2) 540 and the third processing element (PE3) 550 shown in FIG. 5. Note that under the condition of not affecting the disclosure of the present invention, FIG. 5 only shows three processing elements for illustrative purposes. However, the number of processing elements is not limited in the present invention.

The multiplexing unit is for selectively bypassing at least one of the processing elements (for example, PE1 or PE2 in this embodiment) according to the length of input data when the split-radix based FFT unit performs the FFT computation on the input data. In this embodiment, the multiplexing unit comprises a first multiplexer 510 and a second multiplexer 530. The first multiplexer (MUX1) 510 is for selectively bypassing the PE1 520, and the second multiplexer (MUX2) 530 is for selectively bypassing the PE2 540. Note that the number and the position of the multiplexers depends on the design requirements of the FFT apparatus 500, that is, the number of the multiplexers is not fixed but adjustable, and the configuration of the multiplexing unit shown in FIG. 5 is only an example. Other modified designs obeying the spirit of the invention are possible and also fall into the scope of the invention.

For example, when the split-radix based FFT unit is a radix-2/4/8 FFT unit, the functions of PE1 520, PE2 540 and PE3 550 are the same as those of PE1 210, PE2 220 and PE3 230 mentioned above. Therefore, by selectively bypassing PE2 540 or a combination of PE1 520 and PE2 540, the FFT apparatus 500 can perform the FFT computation on any input data having a size equal to a power of two. For example, when N input data is input to the FFT apparatus 500 and N is 2 to the power of (3k+1), where k is an integer (e.g. k=3 and N=2^{(3k+1)}=1024), the N input data is first fed into the first multiplexer 510, and the first multiplexer 510 delivers the N input data to the second multiplexer 530. Then the second multiplexer 530 delivers the N input data to the PE3 550 to perform the radix 2 FFT computation on the N input data. After being processed by the PE3 550, the N input data is broken into two parts both having a size equal to 2^{3k}. Hence, the processed input data can be delivered to the input end of the FFT apparatus 500 from the output of the PE3 550 for further FFT computation carried out by the radix-2/4/8 FFT unit composed of the PE1 520, PE2 540 and PE3 550 sequentially (at this time, the first multiplexer 510 delivers the processed input data to the PE1 520, and the second multiplexer 530 delivers the output of the PE1 520 to the PE2 540), until the process of FFT computation is finished.

In another case where N is 2 to the power of (3k+2), and k is an integer (e.g. k=3 and N=2^{(3k+2)}=2048), the first multiplexer 510 delivers the N input data to the PE1 520, while the second multiplexer 530 bypasses PE2 540 and delivers the output of the PE1 520 to the PE3 550. As mentioned above, PE1 520 together with PE3 550 form a radix 2/4 FFT unit, therefore, the N input data is broken into two parts both having a length equal to 2^{3k}. Hence, the processed input data can be delivered to the input end of the FFT apparatus 500 for further FFT computation carried out by the PE1 520, PE2 540 and PE3 550 sequentially until the process of FFT computation is finished. Similarly, if N is 2 to the power of 3k, and k is an integer (e.g. k=3 and N=2^{3k}=512), the first multiplexer 510 delivers the N input data to the PE1 520, and the second multiplexer 530 delivers the output of the PE1 520 to the PE2 540 to let the N input data be processed by PE1 520, PE2 540 and PE3 550 sequentially, which in fact is equivalent to a radix-2/4/8 FFT computation.

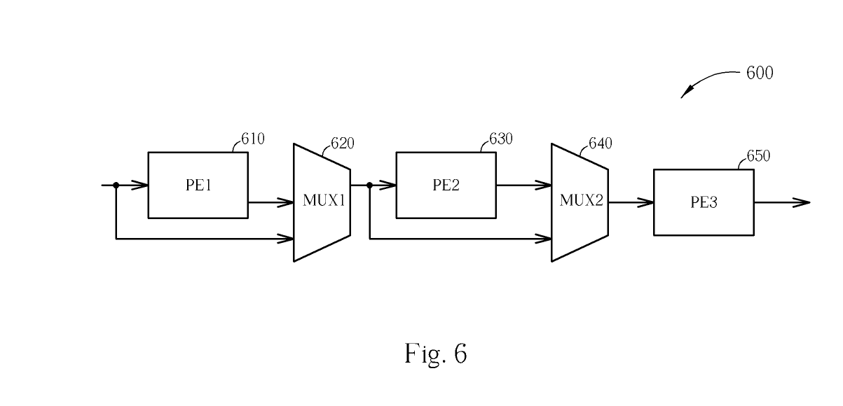

FIG. 6 is a block diagram of an FFT apparatus according to another exemplary embodiment of the invention. The FFT apparatus 600 comprises a split-radix based FFT unit and a multiplexing unit. In this embodiment, the split-radix based FFT unit comprises a plurality of processing elements cascaded in a series, such as PE1 610, PE2 630 and PE3 650 shown in FIG. 6. Note that under the condition of not affecting the disclosure of the present invention, FIG. 6 only shows three processing elements for illustrative purposes. However, the number of processing elements is not limited in the present invention.

The multiplexing unit is for selectively outputting the N input data or an output of a specific processing element as an input of a final processing element (e.g. PE3 650 in this embodiment) of the split-radix based FFT unit according to a value of N, wherein the specific processing element precedes the final processing element. In this embodiment, the multiplexing unit comprises a first multiplexer 620 and a second multiplexer 640. The first multiplexer 620 is for selectively outputting the N input data or an output of the PE1 610 to the PE2 630, and the second multiplexer 640 is for selectively outputting an output of the PE2 630 or an output of the first multiplexer 620 to the PE3 650. Note that the number and the position of the multiplexers depend on the design requirements of the FFT apparatus 600, that is, the number of the multiplexers is not fixed but adjustable, and the configuration of the multiplexing unit shown in FIG. 6 is only an example. Other modified designs obeying the spirit of the invention are possible and also fall within the scope of the invention.

Different from the FFT apparatus 500 in FIG. 5, the FFT apparatus 600 utilizes the multiplexing unit to select if the computation results of the processing elements are adopted or not. However, the objective of the selection is also to bypass some specific processing elements. Taking a radix-2/4/8 FFT unit as an example of the split-radix based FFT unit, the functions of the PE1 610, PE2 630 and PE3 650 are substantially the same as those of the PE1 520, PE2 540 and PE3 550 in FIG. 5. If the size of the input data N is 2 to the power of (3k+1), and k is an integer, the first multiplexer 620 outputs the N input data to the PE2 630 and the second multiplexer 640, and the second multiplexer 640 outputs the output of the first multiplexer 620 (i.e. the N input data) to the PE3 650. The operations of the first multiplexer 620 and the second multiplexer 640 make the input of the PE3 650 be the N input data, that is, the calculation results of the PE1 610 and PE2 630 are omitted, and the N input data is broken into two parts both having a size equal to 8^{k} by the PE3 650.

Similarly, if N is 2 to the power of (3k+2), and k is an integer, the first multiplexer 620 outputs the calculation result of the PE1 610 (i.e. the N input data processed by the PE1 610), and the second multiplexer 640 outputs the output of the first multiplexer 620 as the input of the PE3 650. In this way, the calculation result of the PE2 630 is omitted, and the objective of bypassing the PE2 630 is accomplished. Furthermore, when N is 2 to the power of 3k, and k is an integer, the calculation results of PE1 610 and PE2 630 will not be omitted, which means that the first multiplexer 620 outputs the calculation result of the PE1 610 to the PE2 630 and the second multiplexer 640, and the second multiplexer 640 outputs the calculation result of the PE2 630 as the input of the PE3 650 to achieve a radix-2/4/8 FFT computation.

Compared to the conventional radix-2/4/8 FFT unit 200 which can only handle input data having a size equal to a power of eight, the FFT apparatus 500 and 600 are flexible for any FFT size. As for the FFT apparatus 300, the FFT apparatus 500 and 600 have simpler structures where more memory space is saved and the computation time of multiplying the output of a butterfly by the twiddling factor is reduced. Moreover, a coordinate rotation digital computer (Cordic) algorithm can be implemented in the above embodiments of the present invention to replace the multiplications of the twiddling factors with additions and subtractions in order to further reduce computation time spent on performing the FFT computation. Since the implementation of the Cordic algorithm in the FFT computation is familiar to those skilled in the art, further description is omitted here for brevity.

Please note that, although the above embodiments take the radix-2/4/8 FFT as an example to introduce the spirit of the invention, this is not meant to be a limitation of the implementation of the invention. Other split-radix based FFT unit may also be utilized in another embodiment of the invention. This still obeys the spirit of the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An FFT apparatus for performing an FFT computation on N input data, comprising:
a split-radix based FFT unit, comprising a plurality of processing elements cascaded in a series; and
a multiplexing unit, coupled to the split-radix based FFT unit, for selectively bypassing at least one of the processing elements according to a value of N when the split-radix based FFT unit performs the FFT computation on the N input data.

2. The FFT apparatus of claim 1, wherein the split-radix based FFT unit is a radix-2/4/8 FFT unit.

3. The FFT apparatus of claim 2, wherein the radix-2/4/8 FFT unit comprises a first processing element, a second processing element and a third processing element connected in a series, and the multiplexing unit selectively bypasses the second processing element or a combination of the first processing element and the second processing element according to the value of N when the radix-2/4/8 FFT unit performs the FFT computation on the N input data.

4. The FFT apparatus of claim 3, wherein when N is 2 to the power of (3k+1), and k is an integer, the multiplexing unit bypasses the first processing element and the second processing element.

5. The FFT apparatus of claim 3, wherein when N is 2 to the power of (3k+2), and k is an integer, the multiplexing unit bypasses the second processing element.

6. The FFT apparatus of claim 3, wherein when N is 2 to the power of 3k, and k is an integer, the multiplexing unit lets the N input data be processed by the first processing element, the second processing element and the third processing element.

7. The FFT apparatus of claim 1, implemented in an orthogonal frequency division multiplexing (OFDM) system.

8. The FFT apparatus of claim 7, wherein the OFDM system is a digital audio broadcasting (DAB) system.

9. An FFT apparatus for performing an FFT computation on N input data, comprising:
a split-radix based FFT unit, comprising a plurality of processing elements cascaded in a series; and
a multiplexing unit, coupled to the split-radix based FFT unit, for selectively outputting the N input data or an output of a specific processing element as an input of a final processing element of the split-radix based FFT unit according to a value of N when the split-radix based FFT unit performs an FFT computation on the N input data, wherein the specific processing element precedes the final processing element.

10. The FFT apparatus of claim 9, wherein the split-radix based FFT unit is a radix-2/4/8 FFT unit.

11. The FFT apparatus of claim 10, wherein the radix-2/4/8 FFT unit comprises a first processing element, a second processing element and a third processing element connected in a series, and the multiplexing unit selectively outputs the N input data, an output of the first processing element or an output of the second processing element as the input of the third processing element according to the value of N when the radix-2/4/8 FFT unit performs the FFT computation on the N input data.

12. The FFT apparatus of claim 11, wherein when N is 2 to the power of (3k+1), and k is an integer, the multiplexing unit outputs the N input data as the input of the third processing element.

13. The FFT apparatus of claim 11, wherein when N is 2 to the power of (3k+2), and k is an integer, the multiplexing unit outputs the output of the first processing element as the input of the third processing element.

14. The FFT apparatus of claim 11, wherein when N is 2 to the power of 3k, and k is an integer, the multiplexing unit outputs the output of the second processing element as the input of the third processing element.

15. The FFT apparatus of claim 9, implemented in an orthogonal frequency division multiplexing (OFDM) system.

16. The FFT apparatus of claim 15, wherein the OFDM system is a digital audio broadcasting (DAB) system.

17. A method for performing an FFT computation on N input data by utilizing a split-radix based FFT unit comprising a plurality of processing elements, comprising:
selectively bypassing at least one of the processing elements according to a value of N when the split-radix based FFT unit performs the FFT computation on the N input data.

18. The method of claim 17, wherein the split-radix based FFT unit is a radix-2/4/8 FFT unit.

19. The method of claim 18, wherein the radix-2/4/8 FFT unit comprises a first processing element, a second processing element and a third processing element connected in a series, and the step of selectively bypassing at least one of the processing elements comprises selectively bypassing the second processing element or a combination of the first processing element and the second processing element according to the value of N when the radix-2/4/8 FFT unit performs the FFT computation on the N input data.

20. The method of claim 19, wherein when N is 2 to the power of (3k+1), and k is an integer, the first processing element and the second processing element are bypassed.

21. The method of claim 19, wherein when N is 2 to the power of (3k+2), and k is an integer, the second processing element is bypassed.

22. The method of claim 19, wherein when N is 2 to the power of 3k, and k is an integer, the N input data is processed by the first processing element, the second processing element and the third processing element.

23. The method of claim 17, implemented in an orthogonal frequency division multiplexing (OFDM) system.

24. The method of claim 23, wherein the OFDM system is a digital audio broadcasting (DAB) system.

25. A method for performing an FFT computation on N input data by utilizing a split-radix based FFT unit comprising a plurality of processing elements, comprising:
selectively outputting the N input data or an output of a specific processing element as an input of a final processing element of the split-radix based FFT unit according to a value of N when the split-radix based FFT unit performs an FFT computation on the N input data, wherein the specific processing element precedes the final processing element.

26. The method of claim 25, wherein the split-radix based FFT unit is a radix-2/4/8 FFT unit.

27. The method of claim 26, wherein the radix-2/4/8 FFT unit comprises a first processing element, a second processing element and a third processing element connected in a series, and the step of selectively outputting the N input data or an output of a specific processing element as an input of a final processing element of the split-radix based FFT comprises selectively outputting the N input data, an output of the first processing element or an output of the second processing element as the input of the third processing element according to the value of N when the radix-2/4/8 FFT unit performs the FFT computation on the N input data.

28. The method of claim 27, wherein when N is 2 to the power of (3k+1), and k is an integer, the N input data is output as the input of the third processing element.

29. The method of claim 27, wherein when N is 2 to the power of (3k+2), and k is an integer, the output of the first processing element is output as the input of the third processing element.

30. The method of claim 27, wherein when N is 2 to the power of 3k, and k is an integer, the output of the second processing element is output as the input of the third processing element.

31. The method of claim 25, implemented in an orthogonal frequency division multiplexing (OFDM) system.

32. The method of claim 31, wherein the OFDM system is a digital audio broadcasting (DAB) system.
